(19) United States
(12) Patent Application Publication
(10) Pub. No.: US 2016/0025614 A1
(43) Pub. Date: Jan. 28, 2016

(54) METHOD AND APPLICATION OF GaPO4 CRYSTAL MICROBALANCE TO HIGH ACID CRUDE CORROSION TESTING

(71) Applicants: THE REGENTS OF THE UNIVERSITY OF CALIFORNIA, Oakland, CA (US); CHEVRON U.S.A. INC., San Ramon, CA (US)

(72) Inventors: Thomas M. DEVINE, Moraga, CA (US); Rajashree CHAKRAVARTI, Berkeley, CA (US); Brian N. PATRICK, El Cerrito, CA (US); Kyrolos Paul EL GIHENY, Oakland, CA (US)

(21) Appl. No.: 14/792,341

(22) Filed: Jul. 6, 2015

Related U.S. Application Data
(60) Provisional application No. 62/020,544, filed on Jul. 3, 2014.

(51) Int. Cl. G01N 17/00

(52) U.S. Cl. CPC G01N 17/006

(57) ABSTRACT

A new technique to measure corrosion rates in naphthenic crudes in a high temperature environment has been designed using a gallium phosphate (GAPO) crystal microbalance. The technique is highly sensitive and can measure instantaneous corrosion rates. Due to the high temperature stability of the GAPO crystals, this technique can be used to measure in the laboratory dynamic naphthenic acid corrosion rates of iron at the high temperatures that are prevalent in various locations in oil and gas production and refining facilities, therefore opening a new and more accurate method to study naphthenic corrosion.

### CROSS REFERENCE TO RELATED APPLICATIONS

The present application claims priority under 35 U.S.C. §119(e) to U.S. Provisional Patent Application No. 62/020,544 filed Jul. 3, 2014, which is incorporated herein by reference in its entirety.

### TECHNICAL FIELD

The invention relates generally to systems and methods for characterizing corrosivity of crudes in oil and gas production and refining facilities.

### BACKGROUND OF THE INVENTION

Naphthenic acid corrosion is a known problem in the oil refining industry, particularly in distillation units (Babian-Kibala et al., Mater. Peform. (1993) 3(4):50-55; Derungs. W. A., Corrosion (1956) 42:750-758). However, opportunity crudes which often contain higher concentrations of these acids are becoming increasingly attractive with the depletion of the global reserves of fossil fuels and a more accurate way to assess the corrosivity of these crudes is needed. Currently in the industry total acid number (TAN) is used to assess the corrosivity of a crude oil. TAN indicates the total amount of dissolved acids. However, TAN might not accurately assess the corrosivity as two oils with the same TAN can have significant differences in corrosivity. Many authors have attributed the poor correlation of a crude's corrosivity to its TAN value to the influence of the structure of a naphthenic acid on its corrosivity (Qu et al., Anti-Corros Method M. (2007) 54(4):211-218; Dettman et al., Corrosion (Mar. 22-26, 2009) 09336; Dettman et al., North Area Western Conference, 2010).

Numerous methods have been reported over the years to measure corrosion rates of steels in crudes to gain insight into the mechanism of naphthenic acid corrosion. Measurements of average corrosion rates of coupons and spectroscopic measurements of corrosion-driven changes in the crude's chemistry have been employed to investigate corrosion kinetics (Gutzeit et al., Perform. (1977) 16(10):24-35; Saab et al., Energy Fuels (2001) 15:1498-1504; Piehl et al., Perform. (January 1988) 37-43; Turnbull et al., Corrosion (1998) 54(11):922-930; Slavcheva et al., Corr. J. (1999) 34(2)125-131; Da Campo et al., Energy Fuels (2009) 23:5544-5549; Smith et al., Energy & Fuels (2007) 21:1309-1316; Yepez, O., Fuel. (2005) 84:97-104; Chakravarti et al., Energy Fuels (2013) 27:7905; Fan, T. P., Energy Fuels (1991) 5:371-175.) Corrosion rate measurements in aqueous media have widely been performed by conventional coupon testing, in which weight changes, electrical resistance, and a variety of electrochemical techniques have been used to monitor the coupons. A quartz crystal microbalance (QCM) has also been employed to determine the corrosion rates of metals primarily in aqueous media and was found to be successful in rendering precise values at shorter durations than many other techniques (Seo et al., Sci. A. (1995) 198:197-203; Fontasi et al., Electrochem. Acta. (1998) 44:311-322; Stellnberger, et al., Discuss. (1997) 107:307-322).

It is known that a precise loss or gain of mass can be detected very efficiently by a crystal microbalance. The accuracy of a crystal microbalance in relative mass change detection in real time has been utilized in thin film deposition work. Another manifestation of mass change on the surface is corrosion. The mechanism by which naphthenic acid corrosion generates a loss of mass from oil and gas production and refining equipment is most likely chemical and not electrochemical. Consequently, the mechanism(s) of such corrosion cannot be investigated with the aid of electrochemical techniques. Therefore another attractive area for the application of the crystal microbalance is the laboratory investigation of corrosion in these environments.

Seo et al. studied the corrosion of iron in neutral aqueous solutions and were able to calculate corrosion rates of iron via electrochemical quartz crystal microbalance (EQCM) (Seo et al., Mat. Sci. A. (1995) 198:197-203). Landolt and co-workers studied the adsorption of carboxylic acid onto an iron surface via a rotating QCM in aqueous solution at ambient temperature conditions (Kern et al., Electrochimica Acta (2001) 47:589-598).

Up to this point in the literature however, there have been very few applications of crystal microbalance above room temperature. The reason for this is the temperature sensitivity of the quartz piezoelectric resonator. In order to perform experiments at temperatures above 100° C., precise temperature control is required, which is not feasible in most situations. In addition, there is a phase transformation in quartz at 573° C., which prevents the use of these crystals above this temperature, as well as twinning of the quartz crystal at temperatures above 300-350° C., which also prevents their use. Therefore, to overcome this difficulty, gallium orthophosphate crystal is employed. Gallium orthophosphate (GAPO) is an isomorph of quartz and exhibits the piezoelectric effect. GAPO crystals are unique as the crystals can be employed at temperatures up to 975° C., and the shift in frequency with regards to temperature can be tuned by altering the cut of the crystal (Fritze, H., Mat Sci Tech Ser. (2011) 22:28; Thanner et al., J. Therm. Anal. calorim. (2003) 71:53-59; Thanner, et al., Ann. Chim.—Sci. Mat. (2001) 26(1):161-164). Owing to the unique properties of these crystals, it is possible to perform corrosion experiments in a high temperature refinery type environment.

GAPO has been applied to high temperature systems as a microbalance tool. Jakab et al. studied the dissolution of cerium oxide thin films after heat treatments at 700° C. (Jakab et al., Anal. Chem. (2009) 81:5139-5145). Millichamp et al. applied gallium orthophosphate crystal microbalance as a high temperature sensor in order to detect formation of coke on nickel metal films in solid oxide fuel cells (Jakab et al., Anal. Chem. (2009) 81:5139-5145). Though it is established that a GAPO crystal microbalance is effective at high temperatures, such a balance has not been applied to high temperature refinery type corrosion studies, nor have devices or systems of use in practicing such methods been devised.

As set forth above, a cost-effective, repeatable and reliable device and method for measuring corrosion in refinery environments remains a need in the art. The present invention provides such a device and method.

### BRIEF SUMMARY OF THE INVENTION

Because of market constraints, it is becoming economically more attractive to process highly acidic crudes such as acidic naphthenic crudes. It is well known that processing such acidic crudes can lead to various problems associated with naphthenic acid and other corrosion. Understanding the causes and extent of corrosion of various solutions on one or more of a range of materials is an important element of designing structures that resist such corrosion. The present invention provides robust analytical tools and methods of using these tools to assess corrosion and the corrosive potential of various solutions.

In various embodiments, the invention provides devices, systems and methods for the rapid determination of corrosion rates of a solid material suspended in a solution by measuring the frequency shift that accompanies mass change of a metal-coated crystal sample as the metal dissolves in the solution, and can thus provide reliable empirical data on the corrosivity of a certain solution in a matter of minutes. An exemplary solution is a refinery feedstock, e.g., a high temperature crude oil.

In various embodiments, the present invention provides a GaPO₄ (GAPO) crystal microbalance configured for measuring the corrosive properties of a hydrocarbon-based fluid. The device and method of the invention are of particular use in the investigation of refinery corrosion. The present invention provides devices, systems and methods using a GAPO crystal microbalance as a very effective tool to measure the near-instantaneous corrosion rates of a metal in such environments.

In an exemplary embodiment, the invention provides a GAPO crystal microbalance, and a method of assessing corrosion on the surface of a coated crystal. In this embodiment, the invention allows the operator to query the solid surface of the crystal, at any given time, for the occurrence of mass change (e.g., loss) from the surface. The ability to dynamically query the metal surface allows the in depth mechanistic study of the surface, which was subjected to corrosion. In various embodiments, the device and method are used to measure corrosion rates in crude oil, e.g., naphthenic crudes.

In an exemplary embodiment, the invention provides a device comprised of a dual-chamber apparatus housing a GaPO₄ crystal microbalance having at least a portion of one surface coated with a metal, e.g., iron. The device of the invention is of use to measure corrosion rates in hydrocarbon based fluids, e.g., high acid crudes.

The invention also provides methods of measuring corrosion attributable to refinery feedstocks and other high temperature or hydrocarbon-based fluids. In an exemplary method of the invention, the first chamber of a device of the invention is charged with the fluid (e.g., a high acid crude) to be tested, while the second chamber contains a metal coated GaPO₄ crystal microbalance in an inert atmosphere. The two chambers are heated concurrently, and once the target temperature is reached, the fluid is quickly transferred from the first chamber to the second chamber housing the metal-coated GaPO₄ crystal microbalance. At this point, the frequency response of the immersed crystal is recorded using a data acquisition system, e.g., a commercially available data acquisition system, for the duration of the test. Once the necessary data is gathered, the system can be shut down and cleaned out, and a new iron-coated crystal placed in the chamber for subsequent testing.

Other aspects, objects and advantages of the instant invention are apparent from the detailed description that follows.

### BRIEF DESCRIPTION OF THE DRAWINGS

FIG. 1. is a graphical display of the time dependence of the corrosion rate of a sample immersed in crude as measured by a device of the invention.

FIG. 2A. FT-IR spectrum of the lab simulated crude (A) before starting the corrosion test (B). After 2 h in contact with the Fe film on GAPO at the test solution.

FIG. 2B. Time dependent depletion of naphthenic acid by the formation of iron naphthenate from FT-IR experiments.

FIG. 3. Corrosion rate vs. time plot for interrupted tests in 3 wt. percent naphthenic acid at 270° C. : First interrupt. ▴: Second interrupt. ♦: Uninterrupted behavior.

FIG. 4A.-FIG. 4D. SEM Micrographs of corroded surface with progression of time at 270° C. in 3 wt. % naphthenic acid:

(A) as sputtered iron surface (5 kV 7,500x);

(B) iron surface after a small positive corrosion rate was established (5 kV 7,000x). See curve in FIG. 3;

(C) iron surface after achieving larger positive corrosion rate (5 kV 7,000x). See ▴ curve in FIG. 3; and

(D) iron surface after achieving steady state corrosion rate for 2.5 hours (5 kV 7,000x). See ♦ curve in FIG. 3.

FIG. 5. SEM Micrograph of corroded surface with progression of time at 270° C. in 3 wt. percent naphthenic acid (5 kV 20 kx). Sample also shown in FIG. 4C under lower magnification. (▴ curve in FIG. 3).

FIG. 6. Schematic diagram of a plausible mechanism of the corrosion at the interface of iron and naphthenic acid.

FIG. 7. shows a schematic diagram of an exemplary device of the invention.

FIG. 8. is a schematic diagram of a portion of an exemplary system of the invention, parts V101 and V102.

FIG. 9. is a schematic diagram of an exemplary system of the invention.

### DETAILED DESCRIPTION OF THE INVENTION

### I. Introduction

In various embodiments, the present invention provides a device, a system incorporating the device and a method for crystal microbalance-based measurement of dynamic corrosion rates in refinery feedstocks and other high temperature or hydrocarbon-based fluids. In an exemplary embodiment, the invention is employed to investigate the naphthenic acid corrosion of iron. The device, system and method of the present invention are very efficient in detecting corrosion over very short times, and therefore, can become an indispensible tool for laboratory investigations of corrosion.

### II. Definitions

The following terms will be used throughout the specification and will have the following meanings unless otherwise indicated.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

As used herein, the term “refinery feedstock” refers to natural and synthetic hydrocarbon-based fluids including but not limited to crude oil, synthetic crude biodegraded oils, petroleum products, intermediate streams such as residue, naphtha, cracked stock; refined products including gasoline, other fuels, and solvents. The term “petroleum products” refer to natural gas as well as crude oil, solid, and semi-solid hydrocarbon products including but not limited to tar sand, bitumen, etc.

Crudes and crude blends are used interchangeably and each is intended to include both a single crude and blends of crudes.

References to naphthenic acid (“NA”) include naphthenate and vice versa unless the context clearly specifies otherwise. The term naphthenic acid refers to all of the carboxylic acid content of a crude oil including but not limited to alkyl substituted acyclics (including “fatty” acids), aromatic acids, carbazoles, and isoprenoid acids. Examples in certain crude oils include complex acid structures with two, three, and even four carboxylic groups (tetrameric acids as well as structures containing heteroatoms (O, O₄, S, OS, O₂S, O₃S, N, NO, NO₂, N₂O).

A “crystal microbalance” refers to a crystal having a surface that is at least partially coated with a deposited layer. The crystal microbalance generally finds use in measuring minute quantities or changes in quantities of a substance. Stress applied to the surface of a crystal generates voltage difference across the crystal. Correspondingly, providing an electric field causes a change the shape of the crystal. These corresponding effects are referred to as the piezoelectric effect and converse piezoelectric effect. Crystals also undergo a mass loading effect. Described by Sauerbrey in 1959, the mass loading effect describes the relationship between mass adsorbed on the surface of the crystal and the oscillating frequency of the crystal. A “crystal microbalance” is of use to determine the change in areal mass density adsorbed on the surface of a crystal by detecting the variation of the resonant oscillating frequency of the crystal. An exemplary “crystal microbalance” is of use to determine the loss of mass from a material attached to the surface of the crystal due to corrosion of that material.

An exemplary “crystal microbalance” system includes a crystal and an oscillating circuit. The oscillating circuit is coupled to the crystal for generating a resonant frequency of the crystal. Because the surface mass loading variation of the crystal is relatively small, the variation of the resonant frequency of the crystal is also relatively small. Thus, a crystal microbalance is generally integrated into a system that includes a means of detecting the signal and a means of amplifying the signal either before or after detection. As will be appreciated by those of skill in the art, detecting and amplifying components and configurations in which such structures are operatively linked to amplify a detectable or detected signal are well-known in the art and are applicable in the invention described herein.

“High temperature”, as used herein refers to temperatures typically associated with refinery corrosion, i.e., from about 100° C. to above 400° C. The GAPO device and the associated procedure are capable of measuring corrosion rates at temperatures significantly higher than 400° C.

### III. The Embodiments

### A. The Device

In various embodiments, the invention provides a device for characterizing the corrosivity of high temperature or hydrocarbon-based fluids, e.g., crude, at high temperature. Generally speaking, the invention is directed to a high temperature crystal microbalance having high temperature couplings to allow changes in the mass of a layer deposited on the surface of the crystal to be measured at high temperatures. Further details of an exemplary device and system incorporating the GAPO crystal microbalance are set forth here in below.

In an exemplary embodiment, the device includes a first chamber in fluidic communication with a second chamber. The first chamber and second chamber are configured to receive, retain and or form a high temperature solution, e.g., a refinery feedstock. The second chamber includes a means for stably retaining a first crystal microbalance (e.g., a bracket, clamp, septum, etc.), and the first crystal microbalance. An exemplary first crystal microbalance includes a surface on which is adsorbed a deposited sacrificial layer, e.g., a metal layer, that undergoes mass change (e.g., loss) on contact with the solution. Exemplary devices further include a heat source for heating the device to a high temperature and maintaining the device at such temperature during a period in which the high temperature solution is incubated. Exemplary devices also include a gas inlet in communication with the interior of at least the second chamber. In various embodiments, the gas inlet is connected to a source of an inert gas.

In an exemplary embodiment, the device includes a second crystal microbalance serving as a reference microbalance. The second crystal microbalance may be uncoated (i.e., no deposited layer), or it may be coated with a layer having a corrosion rate different from that of the deposited layer on the first crystal microbalance. The second crystal microbalance is optionally deployed within the first or second chamber.

An exemplary GaPO₄ crystal microbalance is configured with electrodes on both sides of a thin disk of GaPO₄ crystal. In an exemplary embodiment, the layer of material deposited on a GaPO₄ crystal is a material that is relevant to and utilized in equipment for processing a refinery feedstock. Exemplary deposited layers on the GaPO₄ crystal include metals, e.g., carbon steel or other structural materials commonly used in a refinery. The deposited layer can be applied onto the GaPO₄by any convenient method, e.g., sputter deposition and deposition by pulse laser ablation (PLD). In operation, the deposited layer (e.g., iron, carbon steel, etc.) is placed in contact with the fluid. The deposited layer can cover any useful amount of one surface of the GaPO₄ crystal.

Iron is the major component of carbon steel, which is the material of construction of most oil and gas equipment. It is known that iron is attacked by naphthenic acids present in the crudes, and that equipment is adversely impacted by the formation of soluble corrosion products, which are then released into the hydrocarbon stream. Thus, in an exemplary embodiment, the invention provides a GaPO₄ crystal microbalance with a deposited layer of iron on one surface of the GaPO₄ crystal. Also provided is a system including such a microbalance and a method of using the microbalance to determine corrosivity of a refinery feedstock or other fluid.

The deposited layer can be applied onto the crystal of the microbalance by any convenient method, e.g., sputtering, vapor deposition, electroplating. In operation, the deposited layer (e.g., iron, carbon steel, etc.) is placed in contact with the corrosive solution, e.g., refinery feedstock.

In various embodiments, the device of the invention is configured to operate at high temperatures as that term is defined herein. Thus, an exemplary device is configured to operate within a temperature range of from about 180° C. to about 350° C. As will be apparent to those of skill in the art, the device will preferably also be fully functional within a temperature range of from about ambient (˜25° C.) to about 350° C., or even above 350° C.

The results set forth herein establish that maximum corrosion of iron by a particular high acid fluid takes place in the temperature ranges between 290-320° C., thus, in an exemplary embodiment, the device is fully operable within this temperature range and, preferably possesses good linearity in data acquisition over this temperature range.

The device, e.g., the first and second chambers, is fabricated from any conventional and convenient material. In various embodiments, the material is resistant to corrosion by the fluid that is being analyzed using the device.

### B. The System

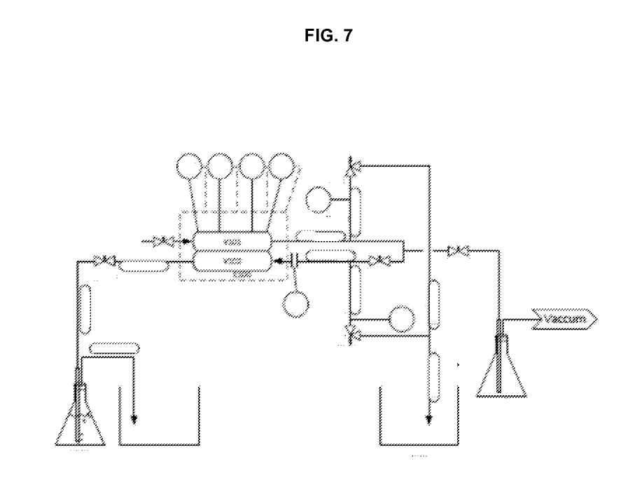

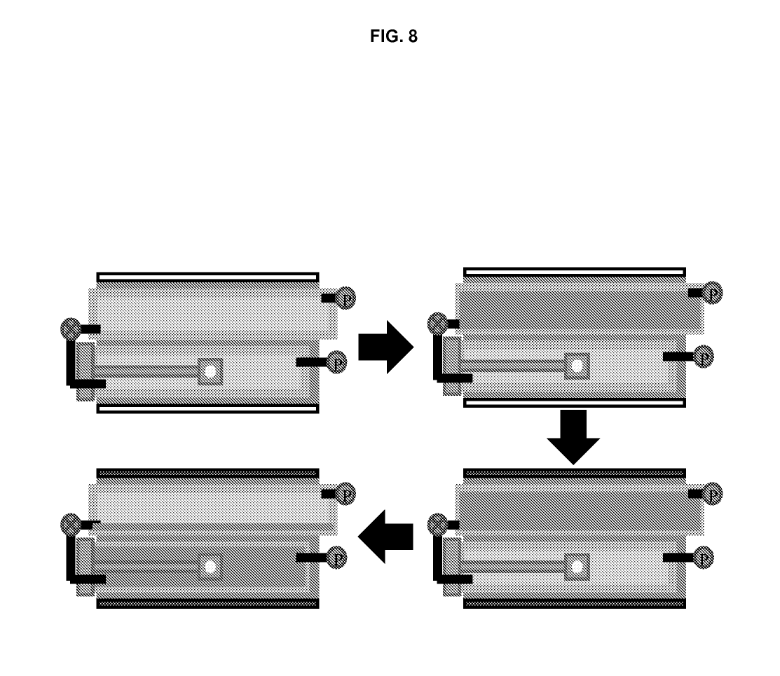

In an exemplary embodiment, the device of FIG. 7 is combined with data collection, analysis and processing components in the system. FIG. 8 shows an exemplary embodiment of V101 and V102 from FIG. 7, which shows one mode for testing. Regardless of its specific implementation, an exemplary device of the invention is capable of docking with or being connected to a system providing one or more of a variety of functions, e.g., providing power to the microbalance or other components in the device, accepting data generated by the microbalance, processing data generated by the microbalance, providing the ability to take user input to control temperature, fluid flow and/or crystal balance operation, etc.

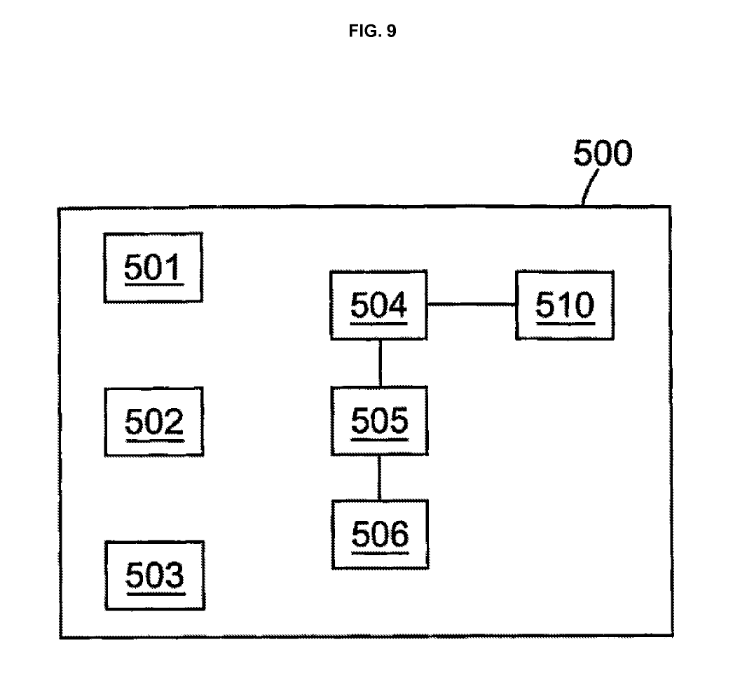

One such system 500 is schematically depicted in FIG. 9, and may include a power source 501 and user interface 502 (e.g., pushbuttons, keyboard, touchscreen, microphone, etc.). The system 500 may also include an identification module 503 adapted to identify a particular device 510 using, e.g., barcodes, radio-frequency identification devices, mechanical structures, etc.

The system 500 may also include a microbalance analyzer 504 that obtains data from a microbalance in the device and a processor 505 to interpret the output of the microbalance. In other words, microbalance analyzer 504 may receive output from a microbalance 510 and provide input to processor 505 so that the output of the microbalance can be interpreted.

Processor 505 receives input from microbalance analyzer 504, which may include, e.g., measurements associated with wave propagation through or over a microbalance. Processor 505 may then determine whether a deposited layer adsorbed to the surface of the microbalance has undergone a reduction of mass. Although the invention is not limited in this respect, the microbalance in device 510 may be electrically coupled to microbalance analyzer 504 via insertion of the device 510 into a slot or other docking structure in or on system 500. Processor 505 may be housed in the same unit as microbalance analyzer 504 or may be part of a separate unit or separate computer.

Processor 505 may also be coupled to memory 506, which can store one or more different data analysis techniques. Alternatively, any desired data analysis techniques may be designed as, e.g., hardware, within processor 505. In any case, processor 505 executes the data analysis technique to determine whether a detectable amount of mass has changed in the deposited layer on the microbalance detection surface of a microbalance in device 510.

By way of example, processor 505 may be a general-purpose microprocessor that executes software stored in memory 506. In that case, processor 505 may be housed in a specifically designed computer, a general purpose personal computer, workstation, handheld computer, laptop computer, or the like. Alternatively, processor 505 may be an application specific integrated circuit (ASIC) or other specifically designed processor. In any case, processor 505 preferably executes any desired data analysis technique or techniques to determine whether a detectable amount of mass has changed in the deposited layer on the microbalance detection surface of a microbalance in device 510.

Memory 506 is one example of a computer readable medium that stores processor executable software instructions that can be applied by processor 505. By way of example, memory 506 may be random access memory (RAM), read-only memory (ROM), non-volatile random access memory (NVRAM), electrically erasable programmable read-only memory (EEPROM), flash memory, or the like. Any data analysis techniques may form part of a larger software program used for analysis of the output of a microbalance (e.g., LABVIEW software from National Instruments Corporation, Austin, Tex.).

Further descriptions of systems and data analysis techniques that may be used in connection with the present invention may be described in, e.g., U.S. Patent Application No. 60/533,177, filed on Dec. 30, 2003, and PCT Publication No. WO2005/06622, entitled “Estimating Propagation Velocity Through a Surface Acoustic Wave Sensor”. Other data analysis techniques to determine the presence (or absence) of mass change in a deposited layer using a microbalance-containing device of the invention may also be used, e.g., time domain gating used as a post-experiment noise reduction filter to simplify phase shift calculations, etc. Still other potentially useful data analysis techniques may be described in the documents identified herein relating to the use of microbalances.

### C. The Methods

The present invention provides a method for determining parameters related to corrosion caused by a refinery feedstock or other fluid. Exemplary parameters include the corrosive potential of the fluid, rate of corrosion of a material in contact with the fluid and, in certain embodiments, the nature or identity of the corrosive agents within the fluid.

In an exemplary embodiment, the invention provides a method of measuring the corrosivity of a high temperature refinery feedstock by determining mass change in a metal layer deposited on a surface of a GaPO₄ crystal microbalance. The method includes, (a) in a device of the invention, incubating the GaPO₄ crystal microbalance with the high temperature refinery feedstock for at least an incubation time sufficient for mass change (e.g., loss) of the metal layer to occur. In a preferred embodiment, the mass change is proportional to the corrosion. Data on mass change from the microbalance is collected and correlated to corrosion.

In an exemplary embodiment, the corrosive properties of the refinery feedstock are characterized using a method of the invention for measuring the corrosion of a layer of structural or other test material deposited on a GaPO₄ crystal configured as a microbalance. Exemplary deposited layers on the GaPO₄ crystal include carbon steel or other structural materials commonly used for corrosion studies. An exemplary GaPO₄ crystal microbalance is configured with electrodes on both sides of a thin disk of GaPO₄ crystal. In operation, the deposited layer (e.g., iron, carbon steel, etc.) is placed in contact with the refinery feedstock.

Iron is the major component of carbon steel, which is the material of construction of many structural components in the refinery. It is well-known that iron is attacked by naphthenic acids present in the crudes and these structures are destroyed by the formation of soluble corrosion products, which are then released into the oil stream. Thus, in an exemplary embodiment, the invention provides a GaPO₄ crystal microbalance with a deposited layer of iron on the GaPO₄ crystal, a system including such a microbalance and a method of using the microbalance to determine corrosivity of a refinery feedstock.

In an exemplary embodiment, at least one resonant frequency of the GAPO crystal microbalance is measured simultaneously with the admittance magnitude at the resonant frequencies. The resonant frequency is correlated with the phase angle of the admittance. As mass loading on the crystal changes, the phase angle of the admittance will move away from an integer of 2n, and the resonant frequency will shift to counteract the change in phase angle. The deposited layer's solid mass change in a particular crude can be derived from the correlated admittance/frequency data, along with properties of the crystal and film.

Thus, in a particular embodiment, the invention provides a method of measuring the corrosivity of a high temperature or hydrocarbon-based fluid by determining mass change from an iron layer deposited on a surface of a GaPO₄ crystal microbalance. The method includes, (a) incubating the fluid in a device configured to measure the corrosivity for at least an incubation time sufficient for mass change from said iron layer to occur. It is generally understood that the mass change is related to the corrosion. In this embodiment, the device includes, (i) a first chamber in fluidic contact with a second chamber. Both the first and second chambers are configured to receive, form and/or retain the fluid. The device also includes, (ii) the GaPO₄ crystal microbalance disposed within the second chamber. In this embodiment, the method further includes, (b) collecting data on said mass change from said GaPO₄ crystal microbalance.

In an exemplary embodiment, the corrosion is at least in part attributable to the presence of naphthenic acids in the fluid. In various embodiments, the method provides a method to correlate the presence and/or concentration of naphthenic acids in a fluid with the measured corrosion or rate of corrosion.

In an exemplary embodiment, the method further includes, (c), prior to step (a), preparing the fluid and microbalance by charging the first chamber with a sample of a refinery feedstock and heating the first chamber and the second chamber to a desired incubation temperature. Exemplary incubation temperatures fall between about 180° C. to about 350° C.

In an exemplary embodiment, the invention provides a method for characterizing corrosion attributable to the dissociation or breakdown of sulfur compounds. It is known that there are a number of different sulfur compounds present in crude, including aliphatic sulfides, disulfides, mercaptans, polysulfides, elemental sulfur, hydrogen sulfide, and thiophenes. In a refinery, sulfur compounds in the crude cause corrosion via different means:

direct reaction with steel equipment producing corrosion products such as iron sulfide, reaction of the sulfur compounds generating corrosive H₂S, and the thermal decomposition of some sulfur compounds above 500° F., which produces H₂S.

Depending on the sample, some preparation may be needed. Preparation for sample analysis prior to characterization may include appropriate steps to remove particulate and/or solid matter, excess water, or other impurities. Excess water may be removed by a process of alternate heating and cooling of the sample, followed by centrifugation to remove the water. Alternatively, the water may be removed manually. The heating process may be carried out in an inert atmosphere, e.g. under vacuum, nitrogen or helium or other inert gases.

In one embodiment, the method is carried out with crude oils being maintained over a range of temperatures representative of the operation in a refinery, e.g., from about 180° C. to about 350° C., e.g, from about 220° C. to about 320° C., etc. In one embodiment, a vacuum is pulled on a sample to achieve a lower boiling point at a given temperature, simulating vacuum distillation conditions. Under vacuum distillation, the relative volatility of components increase, thus reducing the temperature required to bring acids and hydrocarbons to their boiling point, avoiding degradation. Vacuum distillation increases the relative volatility of the key components in many applications. Exemplary refinery feedstocks degrade or polymerize at elevated temperatures, hence, by reducing the pressure and hence, reducing the temperature, certain degradation effects can be avoided.

The following examples are offered to illustrate various embodiments of the invention and should not be construed as limiting the scope of the instant invention.

### EXAMPLES

### Example 1

All chemicals were obtained from commercial sources. Naphthenic acid (Sigma-Aldrich) and RLOP base oil (Chevron) were used to make the lab-simulated crudes. Gallium orthophosphate crystals (Piezocryst) and cool drawer crystal holder (Inficon) were used with a custom-built test cell. Corrosion samples of iron were formed by RF sputter deposition of thin-films from a commercial iron target. Measurements of samples' weight changes were performed with a Maxtek RQCM.

Before each experiment the oil was degassed with nitrogen for 4 h at 80° C. After degassing, the crystal holder and oil were heated to the testing temperature in separate compartments of the cell under a nitrogen atmosphere. After thermal equilibrium was established, the crystal was plunged through a seal into the oil solution and measurements of changes in the sample's mass began. After each test, the sample's surface was inspected with a JEOL field emission scanning electron microscope for evidence of corrosion. FTIR of the starting lab simulated crude and oil samples isolated from the test cell at various intervals and the oil remaining at the end of the test was performed using a Thermofisher Nicolet 6700 FT-IR spectrometer equipped with Omnic software for acquisition and data processing.

### Results and Discussion

Gallium orthophosphate crystal microbalance (GPCM) mass loading was calculated using the method of Lu and Lewis, which accounts for viscoelasticity differences between the thin film sample and the piezoelectric crystal (Lu, et. al., J. Appl. Phys. 1972, 43; 4385-4390). In order to obtain the mass loading on the crystal, the following relationship presented in Equation 1 was applied.

$$Δ m = - {tan}^{- 1} ( tan ( \frac{Δ f π}{{f}_{o}} ) \frac{{z}_{GAPO}}{{z}_{Fe}} ) \frac{{z}_{Fe}}{2 π f} \qquad ( 1 )$$

f₀ is the fundamental frequency (Hz), Δf is the change in frequency (Hz), Z_{GAPO} is the acoustic impedance of gallium orthophosphate (g/(cm²-s), Z_{F0} is the acoustic impedance of iron (g/(cm²-s), f is the frequency at time t (Hz), and am is the mass area density at time t (g/cm²). When applying the crystal microbalance in a liquid, there is also a shift in frequency due to viscous loading of the crystal by the liquid. This viscosity effect can relate the loading to frequency via the following expression in Equation 2 (Kanazawa, et al., Anal. Chem.1985, 57:1770-1771).

Δf=−fₙ^{8/2}(ηᵢρ_{L}/π_{f}L_{GAPO}ρ_{GAPO})^{1/2} (2)

η_{L} is the viscosity of the liquid (Pa-s), and ρ_{L} is the density of the liquid (g/cm³), μ_{GAPO} is the shear modulus of GAPO (GPa), and ρ_{GAPO} is the density of GAPO (g/cm³). However, it has been shown in the literature that equation 1 is still applicable as long as the density and viscosity of the liquid remain constant during the test as temperatures are kept constant (Martin, et al., Anal. Chem. 1991 1091 63:2272-2281). The present invention provides a means to measure near-instantaneous corrosion rates rather than rates that are averaged over relatively long periods of time. Near-instantaneous corrosion rates are important sources of information about the course of the reaction and the corrosion intensity at any instant.

To calculate corrosion rate, the change in mass is divided by the change in time, shown below in Equation 3.

$$CR = \frac{Δ m}{Δ t} \qquad ( 3 )$$

To determine the near-instantaneous corrosion rate, the change in mass of the sample was measured over intervals of five minutes. The five minute time period was the shortest time period that provided a high signal to noise ratio. The GPCM microbalance was calibrated by measuring the viscosity of RLOP base oil and then comparing the measured value to reported data.

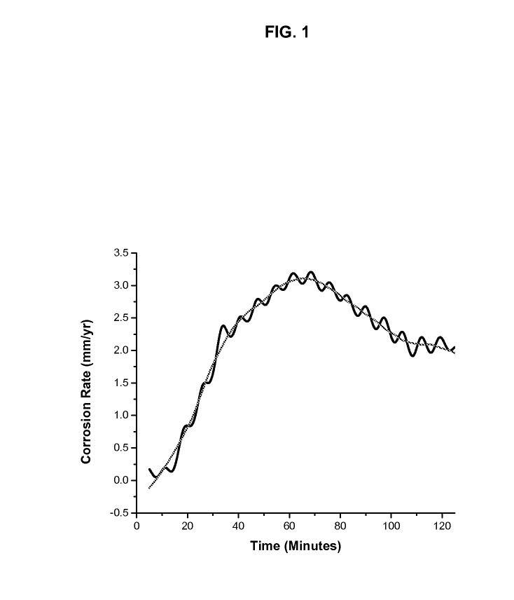

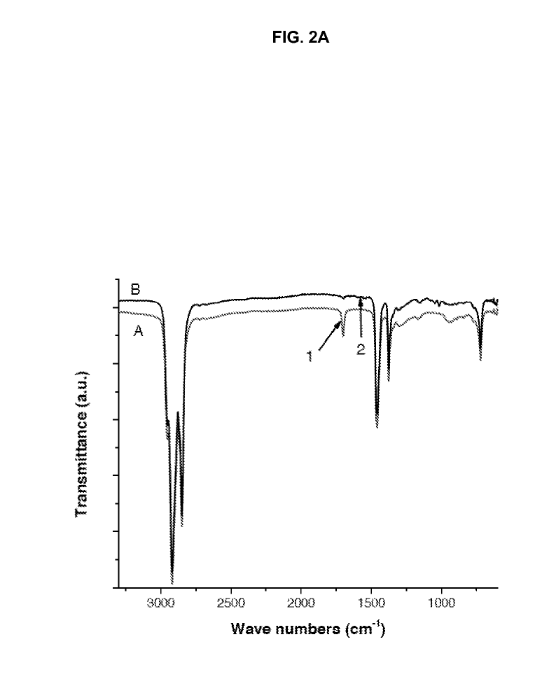

A typical plot showing corrosion rate of iron in RLOP base oil with 3 wt. % NA has three distinct regions, an example of which is shown in FIG. 1. At the initiation of the experiment at times below 10-20 minutes, the crystal is establishing equilibrium with the changing conditions in the surrounding oil mixture. This is confirmed from initial optimization experiments conducted on a gold-coated crystal. As the corrosion rate is calculated over short periods of time, it is seen that at the initial stages of the corrosion reaction, the frequency shift due to the corrosion process is low. Thermal shocks to the crystal, as well as minute frequency changes owing to small temperature differences are the primary reasons for the noise at short times in FIG. 1. The middle region, at times between 12 and 60 minutes, reflects the steady progression of corrosion across the sample's surface, and the eventual achievement of a steady state corrosion rate. The third and the final region (times above approximately 70 minutes) consists of decreasing corrosion rate, which is due to the gradual depletion of surface area of the iron sample, consumption of acid in the solution by corrosion of the iron, or a combination of both.

Iron is the major component of carbon steel, which is the material of construction of many structural components in the refinery. It is well-known that iron is attacked by naphthenic acids present in the crudes and these structures are destroyed by the formation of soluble corrosion products, which are then released into the oil stream. The corrosion process amounts to a metal-ligand reaction between iron and naphthenic acid in non-polar, non-aqueous oil media. The overall reaction can be expressed as (Slavcheva, et al., Corr. J. (1999) 34(2):125-131):

Fe+2RCOOH<>Fe(RCOO)₂+H₂

The corrosion product Fe(RCOO)₂ is highly soluble in oil, and readily goes into solution after formation. This results in a steady depletion of Fe from the surface until the reaction virtually stops when either iron or the acid in the solution is consumed below the threshold of the reaction.

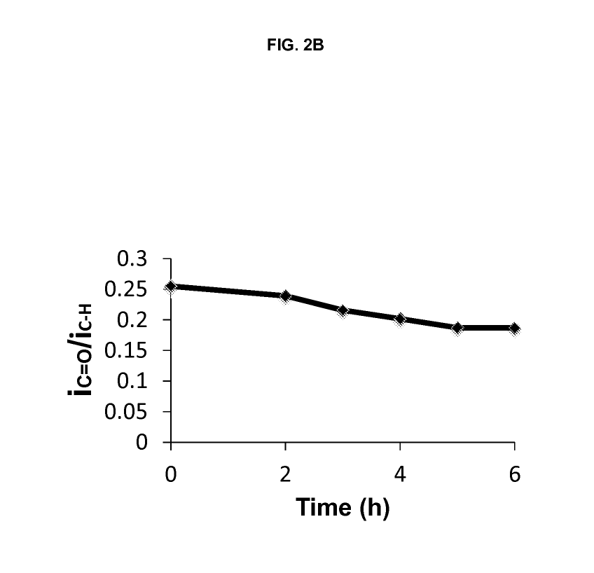

FIG. 1 presents the corrosion rate of iron as a function of time from the advent of immersion in 3 wt. % naphthenic acid. After a very brief period at the beginning of the test in which the sample gained weight, the corrosion rate rapidly increased to a value of around 3.19 mm/yr. After approximately 70 minutes, the corrosion rate began to decrease, which we have found associated with the depletion of the surface area of the iron sample. Another effect that may have been responsible in part for the gradual slowdown of the process of corrosion in the test cell is temperature dependent decomposition or the reaction of reactive shorter chain naphthenic acids with the iron film on GAPO, therefore forming soluble iron naphthenate in the process. The depletion of acid during the course of the corrosion reaction was studied by FTIR spectroscopy (FIG. 2A and 2B) in a separate test. The observation stated above can be observed in FIG. 2A, where in curve A, the region depicted as 1 shows the C═O stretch region of naphthenic acid, which in curve B has decreased substantially to result in the formation of iron naphthenate (2 in curve B) identified by the asymmetric stretch peak of the iron bound carbonyl moiety. The relative acid concentration is reported as the ratio of the peak intensities of the carbonyl stretch associated with the carboxylic acid against the C-H stretch of the alkane solvent.

The experiments involving corrosion rate measurements by GPCM were performed over a range of temperatures, between 200° C. and 320° C. and representative results are presented in Table 1. The corrosion rate vs. time figures can be found in supplemental materials.

TABLE 1
Naphthenic acid corrosion rates of Fe at various temperatures.

| | Maximum Corrosion | Time to Lose | Time to Reach 2 |
|---|---|---|---|
| Temperature | Rate (mm/yr) | 300 μg | mm/yr Rate |
| 220 | 0.143 | — | — |
| 260 | 2.25 | 126.7 | 57.6 |
| 280 | 3.48 | 128.2 | 25.38 |
| 290 | 3.18 | 85.70 | 32.86 |
| 320 | 10.52 | 41.0 | <5 |

The lowest temperature that resulted in a measurable corrosion rate was 220° C. In the test conducted at 220° C. there was an initial period of 15 hours in which the corrosion rate was lower than 0.01 mm/yr. (average value 0.003 mm/yr), however the corrosion rate increased over the next 8 hours at which time the experiment was terminated and the corrosion rate reached its maximum value of 0.135 mm/yr. The time dependent behavior is attributed to (1) the slow rate of penetration of naphthenic acid through the sample's surface oxide during the first 15 h of the test, followed by (2) the direct naphthenic acid attack of bare iron, during which the corrosion rate progressively increased as the surface area of iron in contact with the acid and therefore undergoing corrosion increased.

The values of the maximum corrosion rate as a function of temperature in mineral oil with 3% naphthenic acid are within the range of what has been reported in the literature for pure naphthenic acid corrosion of steel (Qu, et al., Anti-Corros Method M. (2007) 54(4):211-218; Gutzeit, et al., Perform. (1977) 16(10):24-35; Turnbull, et al., Corrosion (1998) 54(11):922-930). In the present study the maximum corrosion rate of iron increased with temperature, with the highest rate taking place at the maximum testing temperature of 320° C. (Table 1). Commercial naphthenic acids are a mixture of aliphatic acids with a range of boiling points (Dettman et al., Corrosion (Mar. 22-26, 2009) 09336; Chakravarti et al., Energy Fuels (2013) 27:7905; Fan, T. P., Energy Fuels (1991) 5:371-175; Hsu et al., Energy Fuels (2000) 14:217-223). Thus, the more reactive, lower molecular weight species slowly decrease in concentration as the temperature is raised over the range of the test temperatures. We believe this to be the reason for the time to achieve a 300 μg weight loss remaining constant between 260° C. and 280° C. A similar result was reported by Turnbull et al., who found the corrosion rate depended on the number of carbon atoms in the naphthenic acid molecule. The corrosion was a maximum for naphthenic acids with around 10 carbons. The corrosion rate slowly decreased with increasing carbon numbers greater than 10 and then resumed increasing at a higher rate with higher carbon numbers (Turnbull et al., Corrosion (1998) 54(11):922-930). Dettmann et al., also found a similar correlation between acid structure and corrosivity, with increasing molecular weight decreasing corrosion in a homologue (Dettman et al., Corrosion (Mar. 22-26, 2009) 09336). It is important to mention that the maximum corrosion rate of a crude of naphthenic acid blend will depend on the structure of the acids present as well as the concentration, and while we found commercial blend is most corrosive at the higher temperature limit of 320° C. on iron, a crude may have its highest corrosivity in a lower or higher temperature range, depending on the boiling points of the constituting acids (Babian-Kibala et al., Mater. Peform. (1993) 3(4):50-55; Dettman et al., Corrosion (Mar. 22-26, 2009) 09336; Behar et al., Org. Geochem. (1984) 6:597-604).

The use of GPCM not only allows for fast measurement of corrosion rates, but also allows for interrupting the corrosion process at precise times and observing the corroded surface closely under a scanning electron microscope. Observing the surface at various stages of the corrosion process has provided insight into the evolution of the corrosion attack, and has provided an explanation for the time dependency of the corrosion rate, as presented in FIG. 1.

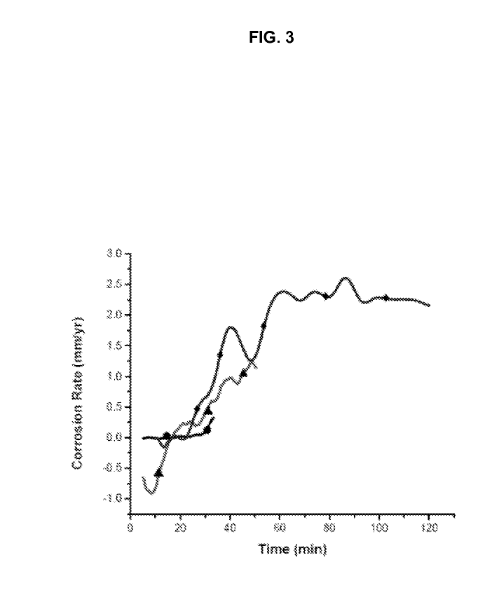

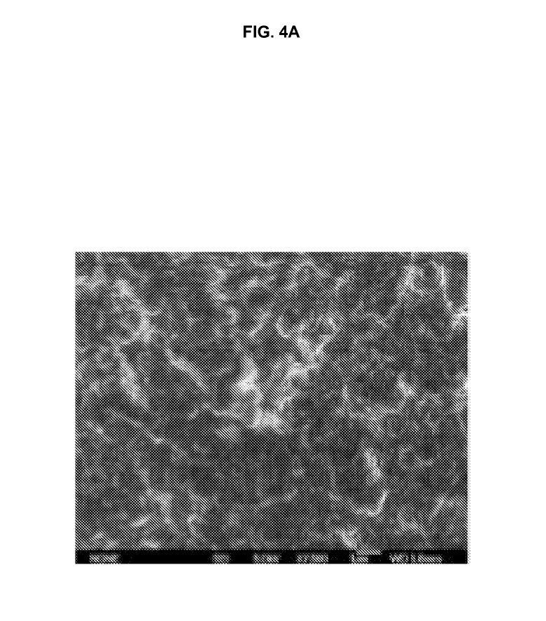

A set of experiments was performed in which the corrosion process was interrupted, and the sample was removed and inspected with a scanning electron microscope. After the SEM examination, the crystal was placed back into the cell, and the experiment resumed until the next predetermined time for interrupting the reaction. The test was first interrupted when a small positive rate of corrosion was first observed. The second interruption occurred further into the region of increasing corrosion rate, near to the steady state corrosion rate. The third test was uninterrupted and shows the microstructure 2.5 hours after corrosion reached a steady state value. The corrosion rate vs. time plots for these tests are presented in FIG. 3.

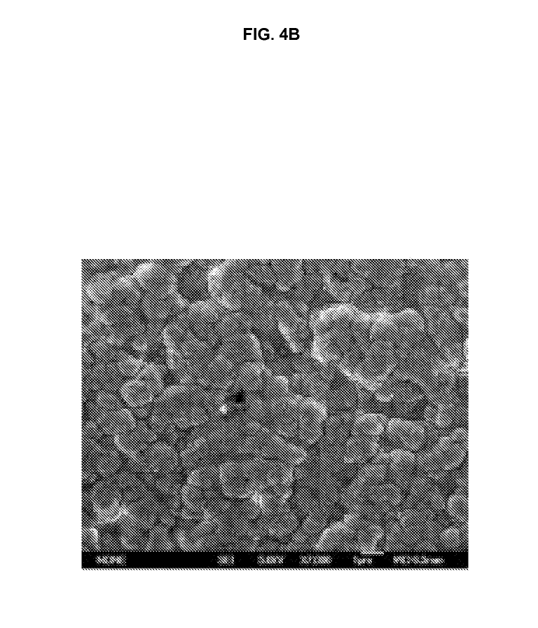

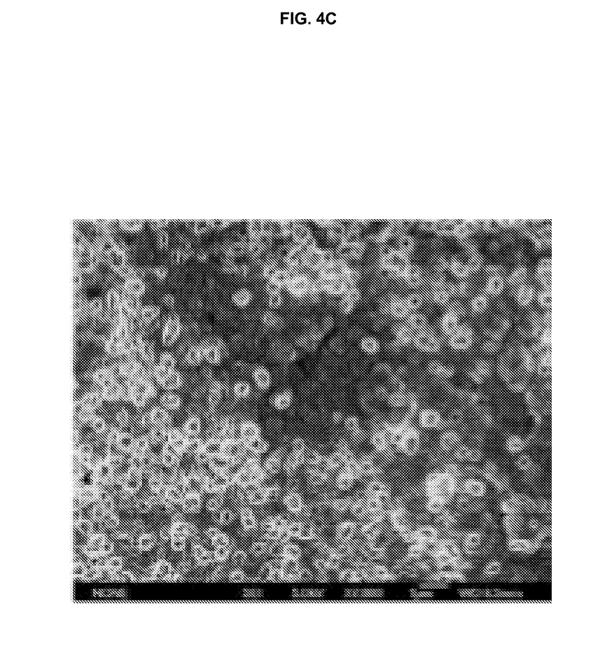

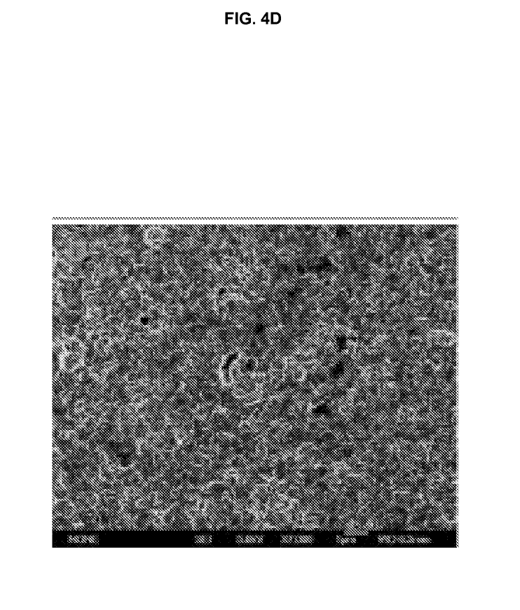

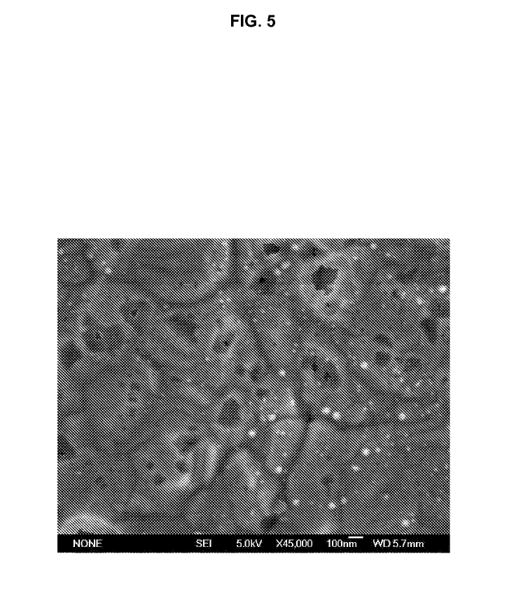

The scanning electron micrographs obtained during the course of this experiment are shown in FIG. 4. FIG. 4A shows the sputter deposited surface. After a small positive corrosion rate was detected, the surface shows the beginning of the corrosion process and the initiation of pits in the oxide in FIG. 4B. However, after a larger increasing corrosion rate was detected, the sample exhibited a significant number of shallow pits as shown in FIG. 4C. The appearance of the surface during steady state corrosion is exhibited by the image presented in FIG. 4D. FIG. 5 shows a region of the sample FIG. 4C under higher magnification. This image reveals the presence of small, crystallographic etch pits in the air-formed oxide that covers the iron's surface. Presumably the small hole, approximately 20 nm in diameter, at the bottom of many of the crystallographic oxide pits is where the corrosion propagated into the iron itself

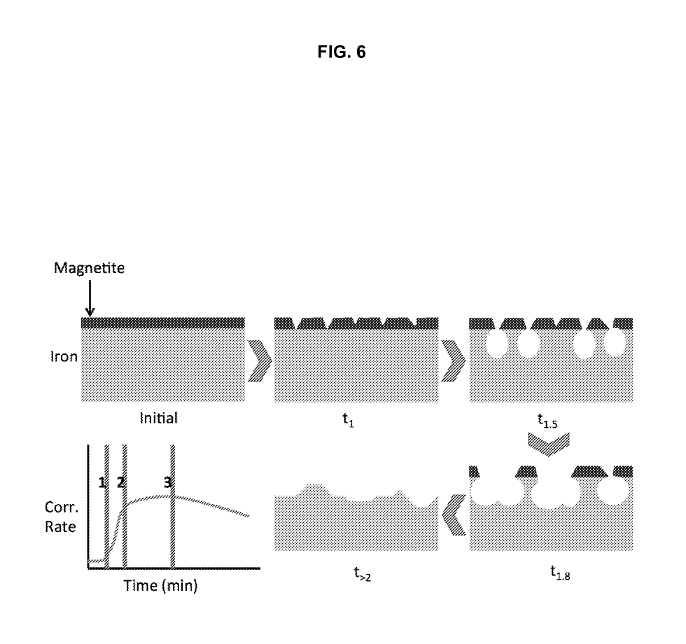

As shown in FIG. 4D, when the corrosion rate reaches a steady state value, the pits have largely vanished and the entire surface is corroded. The evolution of the corrosion, as described by the scanning electron micrographs presented in FIG. 4A-D, combined with the time dependency of the corrosion rate, as indicated by the results presented in FIG. 3, suggests the following scenario. Corrosion initiates by etch pitting of the air-formed oxide (Brantley, S. L., Kinetics of Mineral Dissolution in Kinetics of Water-Rock Interaction; Brantley et al., Ed. 2008. 158-161; Spink et al., J. of Appl. Phys. (1971) 42:511; Stephenson, J. D., Phys. Stat. Sol. (a) (1977) 39(59):89-101). During the etch-pitting stage of the corrosion process the crystal microbalance is able to detect a small loss of mass. Once the oxide is locally penetrated and iron is exposed at the base of etch pits the underlying iron is rapidly corroded. The lateral growth of pits eventually results in impingement of adjacent pits. When the corrosion rate has reached its steady state value, the corrosion attack of iron has entirely undercut the etch-pitted, air-formed surface oxide. The steadily increasing corrosion rate, which began at the time of etch pitting of the surface oxide and concluded when the steady-state corrosion rate was reached, is a consequence of the progressive increase in the surface area of iron undergoing corrosion. This proposed mechanism of naphthenic acid corrosion is summarized in the sketch presented in FIG. 6.

In the examples set forth hereinabove corrosion of iron in high temperature mineral oil with 3 wt. % naphthenic acid was investigated by a combination of dynamic measurements of corrosion rate as a function of time and scanning electron microscopic examination of the corroded surface at various times. Measurements of corrosion rate of iron as a function of time in high temperature oil were made possible by the use of a gallium orthophosphate crystal microbalance. A three stage corrosion process was indicated by the measurement of corrosion rate versus time. In Stage I the iron sample sustained a barely detectable weight loss, which SEM observations indicated was due to initiation of etch pitting of the air-formed oxide. In Stage II the corrosion rate increased with time. In Stage II, corrosion had locally penetrated the air-formed oxide and the underlying iron was rapidly corroding. The lateral growth of pits caused impingement of neighboring pits and undercutting of the etch-pitted oxide. In Stage III, the entire surface of the iron sample was corroding and the corrosion rate reached its maximum and steady-state value.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A device for measuring the corrosivity of a high temperature or hydrocarbon based fluid by determining a mass density change from a metal layer deposited on a surface of a GaPO₄ crystal microbalance, wherein said device comprises:
(a) a first chamber in fluidic contact with a second chamber, wherein each of said first and second chambers is configured to retain said fluid; and
(b) said GaPO₄ crystal microbalance disposed within said second chamber.

2. The device according to claim 1, wherein said metal layer is an iron layer.

3. The device according to claim 1, wherein said fluid is at a temperature of from about 100° C. to above 400° C.

4. The device according to claim 1, wherein said fluid is a crude.

5. The device according to claim 1, wherein said fluid comprises a naphthenic acid.

6. The device according to claim 1, further comprising a heat source for maintaining said fluid at said high temperature, wherein said heating unit is in operative contact with a member selected from said first chamber, said second chamber and a combination thereof.

7. The device of claim 1, said second chamber further comprising a second crystal microbalance deployed therein, wherein said second crystal microbalance is configured as a reference crystal microbalance.

8. A system for measuring the corrosivity of a high temperature refinery feedstock or hydrocarbon-based fluid by determining mass change from a metal layer deposited on a surface of a GaPO₄ crystal microbalance, wherein said system comprises, a device according to claim 1, wherein said GaPO₄ crystal microbalance is operatively linked to a microbalance analyzer for obtaining data from said microbalance.

9. The system according to claim 8, wherein said signal is proportional to mass change from said metal layer.

10. The system according to claim 8, wherein said microbalance analyzer is operatively linked to a processor configured to interpret said data from said microbalance.

11. A method of measuring the corrosivity of a high temperature refinery feedstock or hydrocarbon-based fluid by determining mass change of a metal layer deposited on a surface of a GaPO₄ crystal microbalance, said method comprising:
(a) in a device according to claim 1, incubating said GaPO₄ crystal microbalance with said high temperature or hydrocarbon-based fluid for at least an incubation time sufficient for mass change on said metal layer, wherein said mass change is proportional to said corrosion; and
(b) collecting data on said mass change from said GaPO₄ crystal microbalance.

12. The method according to claim 11, further comprising, processing said data to produce a data set in which amount of mass change is correlated with said incubation time.

13. The method according to claim 11, wherein said incubating is at a temperature of from about 180° C. to about 350° C.

14. The method according to claim 11, wherein said fluid is a crude.

15. The method according to claim 11, wherein said metal layer is an iron layer.

16. The data set acquired by a method according to claim 12.

17. A method of measuring the corrosivity of a high temperature or hydrocarbon-based fluid by determining mass change of a metal layer deposited on a surface of a GaPO₄ crystal microbalance, said method comprising:
(a) incubating said fluid in a device configured to measure said corrosivity for at least an incubation time sufficient for mass change from said layer to occur, wherein said mass change is related to said corrosion, said device comprising:
(i) a first chamber in fluidic contact with a second chamber, wherein each of said first and second chamber are configured to retain said fluid; and
(ii) said GaPO₄ crystal microbalance disposed within said second chamber; and
(b) collecting data on said mass change from said GaPO₄ crystal microbalance.

18. The method according to claim 17, further comprising:
(c), prior to step (a), preparing the fluid and microbalance by charging said first chamber with a sample of a fluid and heating said first chamber and said second chamber to said incubation temperature, thereby preparing the fluid and microbalance for corrosion measurements.

19. The method of claim 17, wherein said incubation temperature is from about 180° C. to about 350° C.
